(19) United States
(12) Patent Application Publication
(10) Pub. No.: US 2008/0128002 A1
(43) Pub. Date: Jun. 5, 2008

(54) CAPSULE DE-DUSTER AND POWDER RECLAMATION APPARATUS

(76) Inventor: Dawnette E. Jeffs, American Fork, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/566,675

(22) Filed: Dec. 4, 2006

(51) Int. Cl. B08B 13/00; B08B 7/00

(52) U.S. Cl. 134/25.4; 134/104.2

(57) ABSTRACT

The present invention relates to apparatus and methods for removing powder from the exterior of capsules. An exemplary capsule removal apparatus includes an input for receiving the one or more capsules having powder thereon. Connected to the input is a screen that is configured to remove the dust from the capsules. The screen may include a plurality of openings therein through which the powder can fall from the capsules. A vibration motor may also cause the screen to vibrate to facilitate the removal of the powder. The screen may further be contained within a housing having a powder collector connected thereto. The powder collector may be a sliding tray within the housing in which the powder is collected as it falls through the screen, thereby allowing the collected powder to be accounted for and optionally reused.

### BACKGROUND OF THE INVENTION

1. The Field of the Invention

Exemplary embodiments of the invention relate to the field of packaging powders in capsules. More particularly, the invention relates to apparatus and methods for removing and collecting excess powder and dust from the capsule exterior.

2. The Relevant Technology

Each year, billions of individual packets of medicines, nutritional supplements, vitamins and the like are packaged, sold and consumed throughout the world. Many of these products are packaged for consumers in predetermined amounts that are appropriate for consumption. For example, a specified number of milligrams of a particular medicine, nutritional supplement, or vitamin may be compressed or baked or compressed into a hard tablet and later consumed. In other cases, medicines, nutritional supplements and vitamins may be encapsulated in an ingestible capsule and later consumed. For instance, gelatin capsules may be used to enclose the medicine, nutritional supplement or vitamin. Thereafter, when a person consumes and digests the gelatin capsule, the capsule breaks down and releases the enclosed substance.

To package medication, nutritional supplements and vitamins in individual capsules, sophisticated equipment has been developed which measures a specified volume or weight of the substance, places it in the capsule, and then seals the capsule. In many cases, the substance that is measured and placed in the capsule is delivered to the packager and/or the encapsulation machine in a powdery or granular form. As a result, the powder or granular substance is then placed in the ingestible capsule.

As specified quantities of powders are measured and encapsulated, some of the powder is released into the environment and accumulates within the encapsulator and/or forms a dust that adheres to the exterior of the individual capsules. While generally harmless, dust on the capsules can be undesirable for a variety of reasons. For example, purchasers and consumers of the capsules may find it objectionable as it may give the capsules a dusty or grainy texture when consumed. In addition, multiple capsules are usually packaged in a container. During shipment and delivery, dust on the capsule exteriors may settle to the bottom container as a powder. Due to the settled powder, the consumer may get the impression that one or more of the capsules in the container has ruptured. In addition, while capsules may enclose a predetermined amount of powder, the excess powder on the capsule exterior is not accounted for with any accuracy, which results in the manufacturer being unable to track costs and/or waste, or determine where losses occur to improve the manufacturing processes. Moreover, powders may be expensive and excess powder on the capsules that is not recovered and reused for enclosure within a capsule adds to the product cost.

To reduce the amount of powder and dust on the individual capsules, capsule polishers have been used in connection with encapsulation machines. In use, a polisher can be connected to the encapsulation machine at the site where the filled capsules are ejected. The ejected capsules enter a central cavity of the polisher in which one or more spiral brushes are located. The spiral brushes rotate and as the capsules enter the cavity, the brushes come into contact with the capsules and also drive the capsules along the cavity. As the capsules are pushed along the brushes can remove the dust from the individual capsules.

While a polisher is often useful for cleaning the dust from capsules, it creates additional concerns or leaves other concerns unresolved. For example, as the polisher removes the dust from the capsules, the dust collects inside the brushes and other moving parts within the polisher. Consequently, powder accumulates in the brushes, gears, and other numerous areas in the polisher and impurities such as metal shavings are combined with the powder. If the powder can be recovered, the addition of metal shavings or other impurities prevents the dust from being accounted for accurately and prevents repackaging of the removed powder. Moreover, it is difficult and time consuming to clean the brushes, gears and other components of the polisher, and recovery of the powder from these components is often impractical, and typically impossible due to the impurities which have been added to the powder. As a result, it is difficult to account for how much powder is removed from the capsules, and such powder is wasted.

When a polisher is used to remove dust from the capsules, the polisher may further be connected to a suction-based dust collection system in which the removed dust is extracted from the polisher by a vacuum. Often, the same dust collection system that extracts the excess dust from the polisher is also used in connection with the encapsulator and with other components in the encapsulation system (e.g., with vacuum shoes, above a powder hopper, and/or around a barrel or canister of the powder being encapsulated) with the dust being collected at a central collector. Moreover, the dust collection system is often used to collect powder from multiple encapsulation systems and rooms. Thus, as the excess powder is collected, the powder from multiple sources is collected in a single location, thereby making it difficult to determine where any specific loss is occurring.

Polishers can also introduce additional concerns that may make encapsulation more costly or may result in capsules that consumers find objectionable. For example, the polisher frictionally engages the capsules to remove the dust, which can heat up the capsules. When some powders are engaged or heated in this manner, the powders may separate or burn, thereby giving the capsules a discolored appearance that is objectionable to consumers. As a result, producers may decide to abstain from polishing capsules of powders that are susceptible to discoloration. Further, the action of the brushes may scar the capsules, which leads to additional consumer complaints. If the polisher rubs the capsules with sufficient force, it may also cause the capsule to rupture. Moreover, the brushes of the polisher are susceptible to occasional jamming. In particular, capsules may be jammed between brushes and/or the polisher's casing, which causes a back-up of capsules. As the capsules back-up, they prevent the encapsulator from releasing the capsules, thereby crashing the encapsulator and often damaging ejection pins in the encapsulator and causing the need for the ejection pins to be replaced. When an encapsulator crashes, the repair costs and the lost productivity can be in the thousands of dollars.

In addition, polishers and their components are expensive. As a result, polishers must undergo frequent maintenance, which is time consuming and also decreases the time during which they can be productively used. Moreover, the brushes and other components wear out and need to be replaced, further requiring that the polisher be shut down, and causing additional costs to replace these parts.

Accordingly, a need exists for an improved capsule de-duster which can be easily maintained and cleaned, and which allows for the efficient recovery of excess powder to facilitate reuse and/or an accounting of the excess powder.

### BRIEF SUMMARY OF THE INVENTION

Exemplary embodiments of the invention relate to apparatus and methods for de-dusting a capsule. More specifically, embodiments of the invention relate to an apparatus for de-dusting a capsule and collecting the removed dust or powder. One feature of removing and collecting dust according to embodiments of the present invention is improved customer satisfaction as dust is reduced from the consumed capsules and capsules are not scarred or discolored. In addition, embodiments of the present invention allow excess powder to be quickly and efficiently collected from capsules such that it can be reused and/or accounted for. Still other features of embodiments of the present invention include components which can quickly and easily be cleaned and non-wear components for increased component life.

In one embodiment, a capsule de-duster is described for removing dust from one or more capsules. The capsule de-duster includes a housing and an input for receiving dust-covered capsules and passing them into the housing. A dust collection system is also included which is at least partially located within the housing and includes a screen connected to the input. The screen may be connected to the input in such a manner that capsules received at the input are passed to the screen. In addition, the screen can be configured to remove dust from the capsules. For example, the screen can optionally be perforated such that dust removed from the capsules passes through the screen. A powder removal mechanism is optionally included in the dust collection system and connected to the screen that removes powder from capsules on the screen. A dust collector may further be positioned in the housing to receive powder removed from the capsules as the removed powder falls through the screen.

In some embodiments, the powder removal mechanism includes a vibration motor connected to the screen. Consequently, the vibration motor can vibrate the screen and shake excess powder from the dusty capsules where it can ultimately be collected in the dust collector for re-use or for an accounting. Optionally, the screen is removable. Moreover, the screen may be gravity fed and/or cascading. Further, a housing may substantially house the screen and/or the dust collector. In some embodiments, the dust collector is slideably connected to the housing.

In other embodiments, a capsule de-duster and powder reclamation apparatus is described which includes a housing, a capsule input connected to the housing, means for removing dust from capsules received at the input, and a powder collector for capturing dust removed from the capsules. The removal means can include, among other things, a vibrating, gravity-fed, inclined, and/or cascading surface along which the capsules are conveyed. Such a surface may include a plurality of holes through which removed dust is passed to the powder collector. The housing can enclose such a surface and can optionally include a window for viewing capsules removed as dust is removed from the capsules. The cover can also include a cover which may be pivotally and/or removably connected thereto. A capsule output may also be connected to capsule conveyor, while the capsule conveyor transports capsules between the input and output, and while the dust is removed from the capsules. The capsule input can further be configured to connect to an encapsulator.

In another embodiment, a capsule de-duster and powder re-claimer is described which includes a housing and a capsule input operatively connected to the housing. An exemplary capsule input can include an opening for receiving capsules from an external source and can pass the capsules into the housing. A conveyor screen may be included within the housing that receives the capsules from the capsule input. Optionally, the conveyor screen includes a plurality of openings through which dust removed from the exteriors of the capsules falls. A vibration mechanism can also be connected to the conveyor screen. As the vibration mechanism vibrates the screen, the vibrations knock dust from the capsule exteriors to allow the dust to pass through the openings in the screen and into a dust accumulator positioned below the openings. The vibration mechanism may be connected to a controller which can vary the magnitude of the vibrations. A support system may also support the housing, allow it to be moved from place to place, and/or have a locking feature to restrain movement of the housing.

In still another embodiment, a method is described for de-dusting capsules. In the method, capsules are received and vibrated to remove dust therefrom. The removed dust is then captured. In some embodiments, capsules are vibrated as they are conveyed along a vibrating surface that includes a plurality of openings through which removed dust falls. Collecting the dust may also include collecting dust in a tray beneath the openings, such that the tray receives the dust as it falls through the openings in the vibrating surface. To receive the capsules, a de-duster may be connected to an encapsulator and thereby receive the capsules as they are ejected from the encapsulator.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of a powder reclamation apparatus according to one embodiment of the present invention, the powder reclamation apparatus having a housing receiving a collection tray, and having a cover in a closed position;

FIG. 1B is a frontal view of the closed powder reclamation apparatus of FIG. 1A;

FIG. 2 illustrates an exemplary embodiment of a powder reclamation apparatus having an open cover exposing a conveyor shelf; and

FIG. 3 illustrates an exemplary embodiment of the powder reclamation apparatus of FIG. 2, and having the cover and conveyor shelf removed.

### DETAILED DESCRIPTION OF THE PREFERRED EMBODIMENTS

Exemplary embodiments of the present invention relate to removal of dust from recently encapsulated powder-filled capsules. More specifically, embodiments of the invention relate to apparatus and methods for removing dust from the exterior of capsules and collecting the removed dust such that it can be reused and/or its loss can be accounted for. In addition, embodiments of the invention relate to de-dusters which have one or more of the following features: cleanable, long-life and easily replaceable components, resistant to crashing an encapsulator, and prevents capsule scarring and powder separation/discoloration.

Reference will now be made to the drawings to describe various aspects of exemplary embodiments of the invention. It is understood that the drawings are diagrammatic and schematic representations of such exemplary embodiments, and are not limiting of the present invention, nor are they necessarily drawn to scale. No inference should therefore be drawn from the drawings as to the dimensions of any invention or element. In the following description, numerous specific details are set forth in order to provide a thorough understanding of the present invention. It will be obvious, however, to one of ordinary skill in the art that the present invention may be practiced without these specific details. In other instances, well-known aspects of vitamins, nutritional supplements, medicines and encapsulators have not been described in particular detail in order to avoid unnecessarily obscuring the present invention.

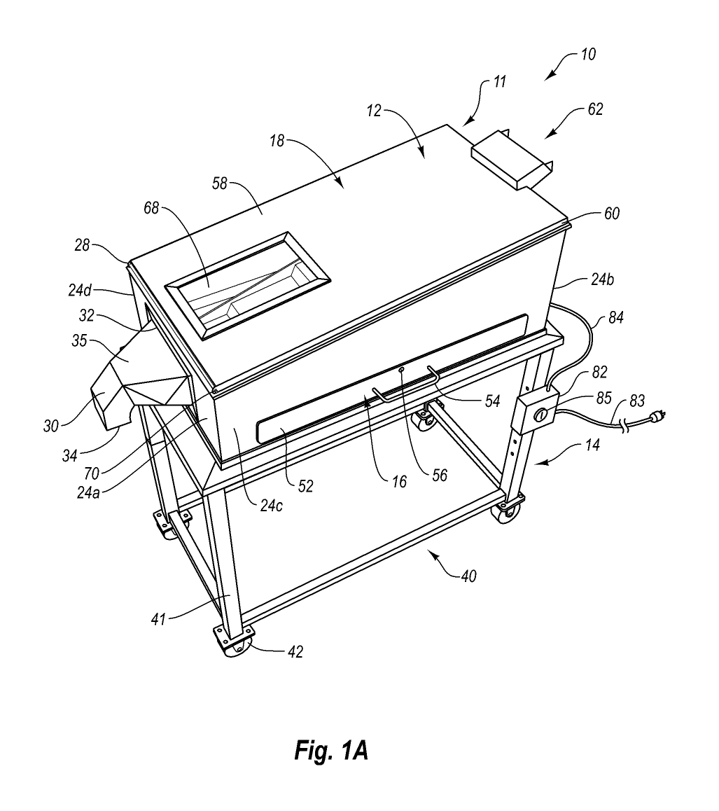

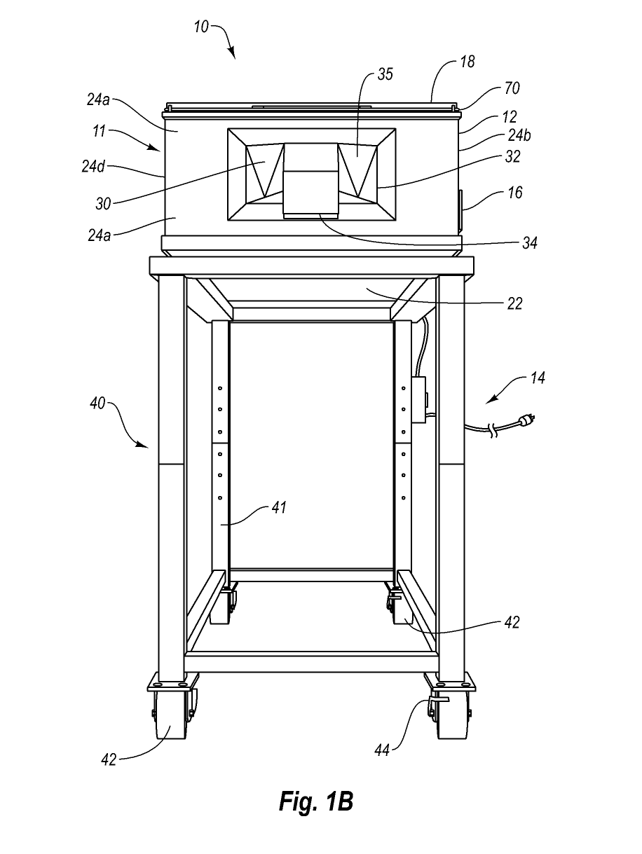

FIGS. 1A and 1B illustrate various views of an exemplary capsule de-duster 10 according to one embodiment of the present invention. In the embodiment illustrated in FIG. 1A, for example, capsule de-duster 10 includes a housing 12 connected to a support 14. As discussed in more detail hereafter, the use of housing 12 with support 14 is desirable for a variety of reasons, although housing 12 can be used without support 14. For example, housing 12 can be configured to receive capsules and remove the dust on the exterior of the capsules, while support 14 may be adapted to stabilize housing 12 and/or to facilitate transportation of housing 12. It will be appreciated by one skilled in the art, that housing 12 and/or support 14 may have various configurations other than those expressly described herein without affecting the function thereof.

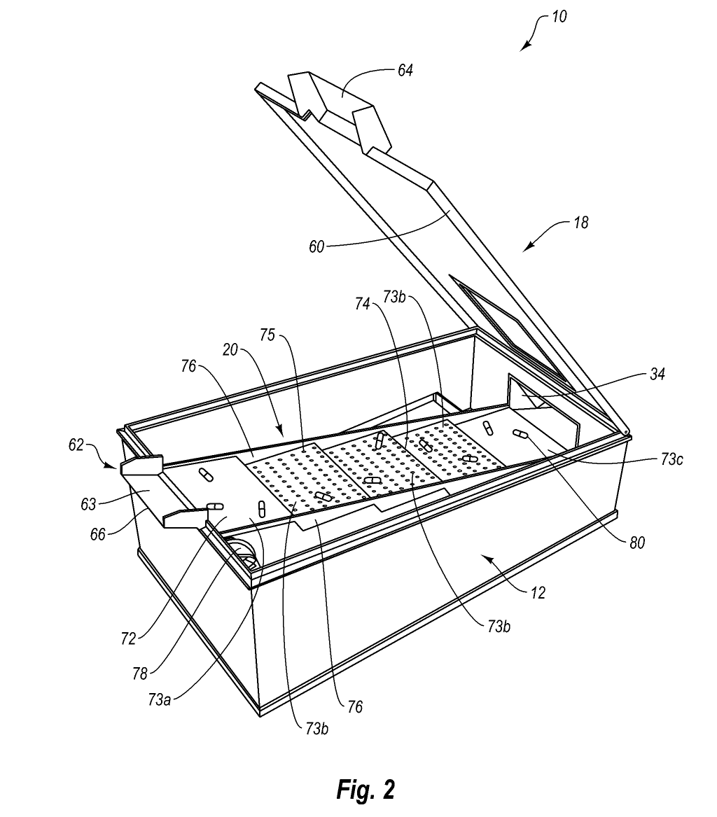

In the illustrated embodiment, housing 12 of capsule de-duster 10 can receive capsules and the dust can be removed from the capsules within housing 12. In one embodiment, by way of example and not limitation, and as discussed in greater detail hereafter, an encapsulator mount 62 can be connected to housing 12 and mounted to a discharge site on an encapsulator such that it acts as a capsule input into capsule de-duster 10. At the discharge site on the encapsulator, the encapsulator ejects capsules which may have powder or dust on their exteriors. As shown most clearly in FIG. 2, as the capsules are ejected, the capsules are received within an input channel 66 of encapsulator mount 62 and are passed into the interior of housing 12 for de-dusting.

As will be appreciated, encapsulator mount 62 can be configured in any suitable manner. For example, in the embodiment illustrated most clearly in FIG. 2, encapsulator mount 62 includes plating or sheeting which forms an opening therein, and which is dimensioned to receive and mate with a discharge site of an encapsulator. In other embodiments, however, the encapsulator mount may have various other configurations without affecting the function thereof For instance, in some embodiments the encapsulator mount includes merely an opening in housing 12 through which capsules are inserted. The opening may also be positioned to receive capsules as they fall from or are otherwise ejected from the encapsulator, without housing 12 being directly mounted to the encapsulator. In other embodiments, an opening or other suitable capsule input is connected to the encapsulator to receive capsules in another manner. For instance, piping, conveyors, additional sheeting, and the like may link housing 12 to the encapsulator. As will also be appreciated, in some embodiments, encapsulator mount 62 is selectively configurable and/or adjustable so as to allow it its configuration and/or size to be changed to mate with encapsulators having discharge sites of varying shapes, sizes, and configurations.

Once capsules have been received through encapsulator mount 62 or any other suitable capsule input, dust may be removed from the capsule exteriors. In the illustrated embodiment, this takes place in a closed environment within the interior of housing 12, and may be done in any suitable manner. For instance, and as discussed in greater detail hereafter, a vibrating conveyor surface can be used to remove the dust from the capsules.

When dust is removed within housing 12, the removed dust may further be collected. As a result, the collected dust can be, for example, reused and/or accounted for to determine at which point during an encapsulation process the powder is being lost. For example, in the embodiment illustrated in FIG. 1A, housing 12 includes side panels 24a-d. In one possible embodiment, and by way of example and not limitation, a collector opening (not shown) is formed in right side panel 24c through which a collection tray 16 is slideably mounted. As dust is removed from the capsules within housing 12, the dust can settle into collection tray 16. At the end of a production run, or at another suitable time, an operator can remove collection tray 16 and weigh or otherwise measure the dust collected therein. In this manner, the excess powder that would otherwise be lost during encapsulation can be accounted for at the end of the run. Optionally, depending on the type of powder and associated quality requirements, the powder can be reintroduced into the powder supply and used in one or more subsequent product runs.

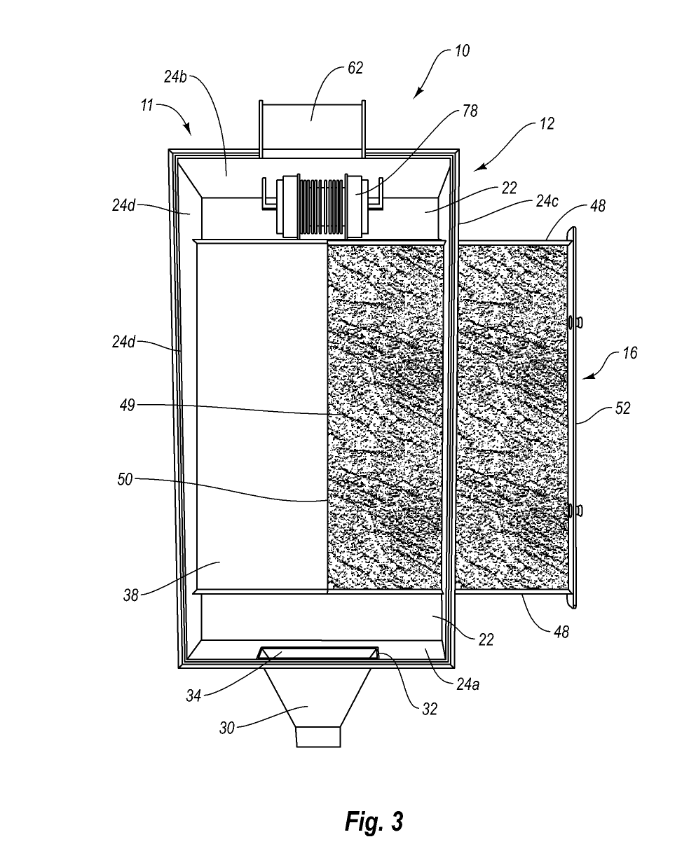

Collection tray 16 may be configured to be locked into place and/or configured for quick and easy insertion and removal. For example, in one possible embodiment, collection tray 16 includes a front panel 52 which abuts right side panel 24c of housing 12 when collection tray 16 is slideably inserted into a tray opening (not shown). An optional locking hole 56 can be formed on front panel 52 and/or one or more handles 54 or knobs may also be secured thereto. Handle 54 can easily be gripped by an operator thereby allowing the operator to easily slide collection tray 16 in and out of housing 16. It will also be appreciated by one skilled in the art that handle 54 may have various other configurations without effecting the function thereof For example, while FIG. 1A illustrates a single handle 54 on front panel 52, multiple handles or knobs (see, e.g. FIG. 3) may be coupled to front panel 52, front panel 52 may have one or more tabs cut therein to allow a user to easily grip and slide collection tray 16.

Locking hole 56 may further be mated with a corresponding opening in right side panel 24c and a locking pin (not shown) can be inserted therein to maintain collection tray 16 in an inserted position. It should be appreciated, however, that a variety of other locking devices and locking means are contemplated. For instance, locking hole 56 may mate with a locking post formed in right side panel 24c of housing 12 and through which a cotter pin can be inserted to maintain collection tray 16 in a closed position. Alternatively, a lock-and-key assembly, clamp, or any other suitable device or manner for maintaining collection tray 16 in a closed position is contemplated. Similarly, handle 54 may be replaced by multiple handles, one or more knobs, a tether, or any other means or device for facilitating insertion and removal of collection tray 16.

As noted herein, in one embodiment, housing 12 forms a substantially closed environment when dust is removed from inserted capsules. For example, in one possible embodiment illustrated in FIGS. 1B-3, side panels 24a-d are connected to a bottom panel 22 to substantially close off the bottom and sides of housing 12. In addition, as shown in FIG. 1A, housing 12 includes a top cover 18 which closes off the top portion of housing 12. Moreover, in some example embodiments, and as discussed in greater detail herein, top cover 18 is optionally removable and/or repositionable, such that housing 12 is, in some embodiments, configured to selectably define a substantially closed environment. It will be appreciated by one skilled in the art that while housing 12 is illustrated as being substantially rectangular in shape, housing 12 can have various other configurations without affecting the function thereof, and that no particular shape or configuration of housing 12 is limiting of the present invention. By way of example and not limitation, housing 12 could alternatively be substantially cylindrical, spherical, cubic, or any variety of other regular or irregular shapes.

A closed or substantially closed environment, such as that defined by housing 12, is desirable in that it minimizes the area over which the removed dust can be displaced by preventing the dust from escaping into the ambient. Consequently, when dust is removed from the capsules located within housing 12, the dust can settle only within the small, defined space of housing 12, thereby allowing for efficient and effective collection and/or accounting of the removed dust.

In some embodiments, top cover 18 is adjustable and/or removable. For instance, in one possible embodiment illustrated in FIGS. 1A and 1B, top cover 18 is pivotally attached to the side panels 24c-d of housing 12. More specifically, in the embodiment illustrated, top cover 18 includes a pivot pin 70 pivotally attaching top cover 18 to side panels 24c-d. It will be appreciated that alternatively, top cover 18 could be pivotally attached to other of the side panels 24a-d without affecting the function thereof In any such example embodiment, an operator can reposition top cover 18 as necessary or desirable during operation, maintenance, repair, or the like of capsule de-duster 10. For instance, after a production run, top cover 18 can be rotated or removed such that housing 12 is no longer a closed environment. By opening housing 12, an operator of capsule de-duster 10 may be provided with convenient access to the interior of housing 12 and can thereby access one or more of the components or features therein. Consequently, during or after a production run, the operator can collect and/or remove any capsules which have not been discharged from housing 12 or clear a jam of the capsules in the event one occurs. The ease with which the interior of housing 12 can be accessed reduces the chance that capsules will be damaged during such an incident. Further, components within capsule de-duster 10 can be accessed to facilitate inspection, removal, replacement, cleaning, and/or maintenance. Moreover in other embodiments, one or more of side panels 24a-d (e.g. side panel 24d) may alternatively or additionally be removably connected to bottom panel 22, thereby further allowing an operator or another person easy access to the interior of housing 12.

As illustrated in one embodiment depicted in FIG. 1A, top cover 18 also includes an optional window 68 into which an operator can look to view the interior of housing 10. Accordingly, the operator or another can view the capsules and operation of capsule de-duster 10 as the capsules are being de-dusted. In one possible embodiment, window 68 is optionally fitted with a transparent material such as glass or a translucent plastic. It should be appreciated, however, that window 68 is merely one example of a window and of a means for visible inspection of the interior of housing 12. In other embodiments it is contemplated, for example, that a window be sized to cover substantially the entire surface of top cover 18. In still other embodiments, top cover 18 may be made of a transparent material such that a separate window is not necessary, or one or more windows can be formed in side panels 24a-d instead of, or in addition to, window 68 in top cover 18. In still another embodiment, top cover 18 or side panels 24a-d may include an opening which is not covered with another material so as to allow the user to visibly inspect and/or easily access the interior of housing 12 even without removal or opening of top cover 18 or side panels 24a-d.

As further illustrated in FIGS. 1A and 1B, housing 12 may include or be connected to a capsule discharge 30 through which de-dusted capsules are removed from capsule de-duster 10. In the exemplary embodiment illustrated in FIGS. 1A and 1B, for example, an opening 32 is formed in front side panel 24a. Metal or plastic sheeting or paneling borders the exterior face of front side panel 24a adjacent opening 32 and is configured to direct the output of capsules as they are discharged from capsule de-duster 10. For example, metal sheeting 35 near opening 32 may be formed to create a discharge channel 34 from which de-dusted capsules are ejected into a collection receptacle, and from which they can then be packaged and shipped to a consumer or retailer.

In light of the disclosure herein, it will be appreciated that capsule discharge 30 can also be configured to facilitate operation of capsule de-duster 10 with a polisher. For example, the sheeting or paneling forming part of capsule discharge 30 can be dimensioned similar to a discharge site of an encapsulator. In this manner, a polisher can be connected to capsule discharge 30 and, after capsules are de-dusted by capsule de-duster 10, they can be further cleaned or polished by the polisher. It should be appreciated, however, that it is not necessary that capsule discharge 30 be adapted to mate in this manner with a polisher. For instance, in other embodiments capsule discharge 30 may taper and direct capsules into a polisher without connecting to or mating with the polisher. Moreover, inasmuch as capsule de-duster 10 removes dust from received capsules it may be unnecessary to use an additional polisher with the capsules. Accordingly, capsule de-duster 10 can be used to remove dust from capsules and may operate with or without further cleaning by a polisher.

In addition, while capsule discharge 30 is illustrated as including sheeting 35 extending from opening 32, it should be appreciated that this is exemplary only. In other embodiments, capsule discharge 30 may include only opening 32 through which de-dusted capsules are discharged or may include a tray in which de-dusted capsules are captured. In still other embodiments, capsule de-duster 10 may not include a separate opening for discharging capsules from de-duster 10. For example, housing 12 may include a collection unit within the interior of housing 12 into which de-dusted capsules are discharged and collected. During or after a production run, an operator may then remove the capsules by, for example, rotating and/or removing top cover 18 or one or more of side panels 24a-d (e.g. side panel 24d) of housing 12.

As noted previously, and as depicted in FIGS. 1A and 1B, capsule de-duster 10 may include a support 14 which is removably or permanently coupled to housing 12 so as to stabilize and/or facilitate the transport of housing 12. In one possible embodiment illustrated in FIGS. 1A and 1B, optional support 14 is positioned directly under housing 12, and thereby directly supports the weight of housing 12.

Support 14 may be made in any manner that is suitable for supporting and/or transporting housing 12. Accordingly, support 14 may be integral with or detachable from housing 12. In the embodiment depicted in FIG. 1B, for example, support 14 includes a frame 40 made of a variety of bar members to which housing 12 is connected. It should be appreciated in light of the disclosure herein that housing 12 may be connected to frame 40 in any suitable manner. In addition, housing 12 may be welded or otherwise permanently connected to frame 40. In other embodiments, housing 12 is not permanently connected to frame 40. For instance, housing 12 may be temporarily and/or removably connected to frame 40 through the use of bolts, clamps, or other mechanical fasteners. In still other embodiments, housing 12 is placed on frame 40 and connected thereto without any mechanical fasteners or permanent connection. For instance, housing 12 may be set on frame 40 and secured thereto by frictional forces.

Support 14 may further be configured to allow housing 12 to be quickly and easily connected to an encapsulator so as to receive capsules discharged therefrom. For example, frame 40 can be dimensioned such that when housing 12 is connected to frame 40, and frame 40 is positioned near the encapsulator, encapsulator mount 62 on housing 12 mates directly with the discharge site in the encapsulator. In some embodiments, frame 40 has a fixed height and/or other fixed dimensions to facilitate this connection; however, it will be appreciated in light of the disclosure herein that the dimensions of frame 40 may also be variable, and thereby allow frame 40 to adjust as necessary for different encapsulators or for other reasons. For instance, in the embodiment depicted in FIGS. 1A and 1B, frame 40 includes vertical support members 41 which are height adjustable. To allow vertical support members 41 to be height adjustable, vertical support members 41 may include a set of slots in which a retractable, spring-loaded pin can be fitted. However, other adjustment means are contemplated and suitable for embodiments of the present invention. For example, a clamp, ratchet mechanism, or other locking member can be used to selectively change the height or dimensions of support 14 and/or maintain vertical members 41 at a particular height.

In other embodiments, frame 40 is not dimensioned to allow direct connection of housing 12 to an encapsulator. In such a case, housing 12 can be connected to the encapsulator in any of a variety of other manners. For instance, support 14 and/or frame 40 may be omitted. In such a case, housing 12 may be made of lightweight materials to allow it to be easily transported. In still other embodiments, housing 12 is integral with the encapsulator such that the support structure for the encapsulator also supports housing 12. Alternatively, frame 40 may be selectively removable such that housing 12 can be positioned on some other support-such as the floor, a table or the encapsulator itself-to allow housing 12 to receive capsules discharged from the encapsulator.

With continued reference to FIGS. 1A and 1B, it will be seen that in some embodiments support 14 can include coasters 42 or some other optional transport system to facilitate transport of capsule de-duster 10. Coasters 42 support the weight of frame 40 and housing 12 and further allow capsule de-duster 14 to be wheeled or otherwise easily moved between locations. Optionally, coasters 42 can include wheel locks 44 which prevent coasters 44 from rolling and lock support 14 in place. Alternatively, another braking mechanism can be used to reduce the chance that capsule de-duster 10 will be inadvertently moved. For instance, one or more clamps may be connected to frame 40 and which extend to the floor or wall and which frictionally engage the floor or wall, thereby substantially restricting the movement of capsule de-duster 10.

A transport system can be desirable for a variety of reasons. For instance, one feature of a transportable capsule de-duster 10 is that it may be quickly and efficiently moved and, accordingly, can easily be interchanged between multiple encapsulators. As a result, when an encapsulator is undergoing maintenance or cleaning, capsule de-duster 10 can still be used with another encapsulator that is in operation. Moreover, by locking wheel locks 44 on coasters 42, or otherwise restricting the motion of capsule de-duster 10 and frame 40, frame 40 can prevent capsule de-duster 10 from moving while it is in use, while wheel locks 44 or other braking mechanisms can be released so as to allow an operator to quickly and efficiently move capsule de-duster 10 in the event that it needs to be moved to another machine, or if it is to be cleaned, maintained, repaired, or for any other reason.

Now referring to FIG. 2, an exemplary embodiment of the present invention is illustrated in which top cover 18 has been opened to expose the interior of housing 12. In the illustrated embodiment, housing 12 includes a capsule conveyor 20 for delivering capsules 80 from encapsulator mount 62 to capsule discharge 30. More particularly, capsule conveyor 20 receives capsules 80 as they are delivered from an encapsulator or another source, de-dusts capsules 80, and then transfers the de-dusted capsules 80 to capsule discharge 30 to allow the capsules to be inspected and/or packaged for distribution or use.

Capsule conveyor 20 includes, in this embodiment, a conveyor screen 72 which acts as the conveyor for capsules 80. In particular, as capsules 80 are input through encapsulator mount 62, they are guided onto screen 72. In one embodiment, screen 72 includes multiple segments 73a-c which are substantially flat, and includes side walls 76 which are substantially perpendicular to segments 73a-c and which direct capsules 80 to capsule discharge 30. It will be appreciated that screen 72 could, however, have other configurations which perform the functions of side walls 76 and/or segments 73a-c. For example, in an alternative embodiment, side walls 76 are not perpendicular to segments 73a-c, or are removed. By way of example and not limitation, the segments of screen 72 can be recessed or rounded. For instance, screen 72 may have a substantially “V” or “U” shaped cross-section, or be inclined towards one side. In this manner, as capsules are directed onto the screen, they drop into the recessed portion of the screen and can be directed to the capsule discharge 30.

In some embodiments, conveyor screen 72 is inclined. For instance, in the illustrated embodiment, conveyor screen 72 is inclined between a higher positioned encapsulator mount 62 and a lower positioned capsule discharge 30. One feature of a screen 72 that is inclined in this manner is that it allows gravity to assist in the delivery of capsules 80 and, accordingly, may reduce or eliminate the use of moving parts to move capsules 80 along screen 72. For example, in the illustrated embodiment, screen 72 is inclined and is also gravity fed to allow gravity to move capsules 80 from the input to the output of housing 20.

In embodiments where screen 72 is inclined, it will be appreciated that screen 72 may have a constant slope across its length. In other embodiments, however, the slope may vary across the length of screen 72. For example, in the embodiment illustrated in FIG. 2, screen 72 is cascading and has five extended segments 73a-c which each have approximately the same incline, and which are separated by four more narrow segments 74 which each have a steeper incline. It should be appreciated however, that the illustrated configuration is exemplary only and not limiting of the present invention. In particular, it should be appreciated in light of the disclosure herein that screen 72 may have more or fewer sloped segments of any combination of slopes and inclines.

As capsules 80 are received by screen 72 of capsule conveyor 20, they pass over the one or more segments of screen 72 towards capsule discharge 30. As capsules 80 move in this manner, conveyor 20 is further configured to remove dust from capsules 80. Conveyor 80 can be configured to de-dust capsules 80 in any suitable manner. For instance, in the exemplary embodiment illustrated in FIG. 2, screen 72 includes a plurality of perforations 75. Perforations 75 are sized such that they are substantially smaller than the smallest dimension of capsules 80. In this manner, as capsules 80 traverse conveyor 20, capsules 80 do not fall into or through screen 80. Instead, capsules 80 easily pass over perforations 75 without binding thereon. Moreover, perforations 75 can also have any desirable cross-sectional shape or pattern. For instance, perforations 75 may have a circular or elliptical cross-section, may have a square or rectangle cross-section, or may have any other variety of regular, irregular or elongate shapes.

Moreover, perforations 75 are sized such that the particles of powder forming the dust on capsules 80 can fit into and fall through perforations 75. In particular, in one embodiment, such as that illustrated in FIG. 2, as capsules 80 slide along screen 72, friction is created between capsules 80 and screen 72, which removes the dust from the capsule exterior. Accordingly, as capsules 80 move along screen 72, screen 72 can remove all or a portion of the dust collected on capsules 80. Perforations 75 are of a size larger than the particles of dust which are removed, but, in this embodiment, smaller than capsules, such that as the dust is removed by screen 72, the dust falls through screen 72. By having the dust fall through screen 72, the dust is also removed from the conveyor surface along which capsules 80 pass, thereby preventing the displaced powder from reattaching to the same or a different capsule.

In the illustrated embodiment, conveyor screen 72 extends along the length of housing 12 from capsule discharge 30 to encapsulator mount 62, and is approximately the same width as capsule discharge 30 and encapsulator mount 62, and less than the width of housing 12. It should be appreciated, however, that this is exemplary only and that other configurations can be used to perform the same function thereof In other embodiments, for example, all or a portion of conveyor screen 72 is wider or narrower than capsule discharge 30 and/or encapsulator mount 62. For example, in some embodiments screen 72 is substantially the same width as housing 12.

While dust may be removed from capsules 80 by the friction created between capsules 80 and screen 72, capsule conveyor 20 may include, in other embodiments additional or alternative means or components for removing dust. By way of example, in the embodiment best illustrated in FIG. 3, a vibration motor 78 is connected to the interior of housing 12. Vibration motor 78 can also be connected or otherwise linked to screen 72. In alternative embodiments, for example, vibration motor 78 is connected directly to screen 72. As vibration motor 78 accesses power from a power supply, vibration motor 78 thereby causes screen 72 to vibrate.

As screen 72 vibrates and as capsules 80 move along vibrating screen 72, the capsules also vibrate. In addition to any friction between capsules 80 and screen 72, the vibrations cause the excess dust to shake free from the capsule exteriors such that it can then fall through perforations 75. Consequently, vibration motor 78 may remove more dust than would be removed from capsules 80 by merely transferring capsules 80 along screen 72 without the assistance of vibration motor 78. Vibration motor 78, screen 72, and perforations 75 are, therefore, individually and collectively, examples of means for removing dust from capsules received within housing 12.

Another feature of vibration motor 78 is that it allows capsule conveyor 20 to more effectively transport capsules 80 from the capsule input 66 to capsule discharge 30. By way of example, as capsules 80 vibrate and their motion increases, they are better able to overcome frictional forces that might otherwise reduce the sliding or rolling motion of capsules 80 along conveyor screen 72. Accordingly, by vibrating screen 72 and/or capsules 80, the overall degree of incline in screen 72 can be reduced or eliminated. As a result, the height of housing 20 can also be reduced, thereby making capsule de-duster 10 smaller and more compact, and reducing material costs.

While vibration motor 78 is illustrated in the embodiment of FIG. 3 as being connected to the interior of housing 12, it should be appreciated that this embodiment is illustrative only and that in other embodiments, vibration motor 78 may be connected to housing 12 and/or linked to conveyor screen 72 in any of a variety of other suitable manners. For example, vibration motor 78 may be connected to the exterior of housing 12. In other embodiments, vibration motor 78 may be mounted to the underside of conveyor screen 72.

It will also be appreciated that vibration motor 78 is merely one example of a de-dusting mechanism or means for removing dust from capsules 80, and that other means for removing dust from capsules 80 are contemplated. For example, an ultrasonic dust separator may be connected to screen 72 or installed in connection with housing 12 such that as capsules 80 move along conveyor screen 72, the ultrasonic dust separator induces vibrations which shake excess dust off the capsule exteriors. In another example, vibrations may be created by a non-oscillating motor. For example, screen 72 may be movable along a cyclical track, such that the constant speed motor causes the screen 72 to move, thereby inducing vibrations which remove dust from capsules 80.

It will also be appreciated that it is not necessary to vibrate screen 72 to remove additional dust from capsules 80, and that other means for removing dust from capsules 80 may be used without reducing the functionality thereof In another alternative embodiment, for example, means for removing dust from capsules 80 can include a motor connected to a tumbler into which capsules 80 are placed, such that as the tumbler moves, it causes capsules 80 to rub against each other and the surface of the tumbler, thereby removing excess dust from the capsule exteriors. In another embodiment, an air blower or suction device may be used in connection with screen 72 to cause air to flow within housing 12. The air flow caused by such devices may be used to remove powder dust from capsules 80, where it can then pass through perforations 75. Moreover, such an air flow may facilitate movement of capsules 80 along screen 72 by, for example, having irregular or oscillating air flows.

Vibration motor 78, or any other suitable means for removing dust from capsules within housing 12, can receive power from any suitable power supply. In one example embodiment, for example, and as best illustrated in FIGS. 1A and 1B, a power cord can extend from housing 12 and be configured to be connected to a power source. In one example embodiment, an upper portion 84 of the power cord can connect to the vibration motor 78 (see FIG. 3) or any other electrical or mechanical dust removal mechanism, while a lower portion 83 is connectable to an electrical outlet of any suitable type (e.g., 110 volt, 220 volt).

In example embodiments such as that illustrated in FIGS. 1A and 1B, in which the dust removal mechanism is connected to an external power supply, capsule de-duster 10 may optionally include, a controller 82 to further facilitate the removal of dust from the capsules. Controller 82 may facilitate removal of dust from the capsules in a variety of ways. For example, controller 82 may be adapted to allow vibration motor 78 or some other dust removal mechanism to operate with different types of power supplies. For instance, controller 82 may include an AC/DC converter to allow operation with either AC or DC power. Controller 82 can alternatively, or in addition thereto, be configured to vary the power supplied to the dust removal mechanism. For instance, power supply may include a control knob 85 which can be used to increase or decrease the power input to vibration motor 78. Thus, using control knob 85, an operator of capsule de-duster 10 can control how much screen 72 vibrates.

Selective control over the amount of vibration of screen 72 can be desirable for a variety of reasons. For instance, control knob 85 can be used to increase the vibrations to remove powders that are heavier or which more strongly adhere to the capsule exterior surface. Additionally, control knob 85 can be used to reduce the vibrations to conserve power or to turn off the vibrations where not necessary, such as when a production run has been completed.

Although controller 82 is illustrated as having lower power cord 83 which can extend to an electrical outlet to access a power supply, it should be appreciated that a power supply may be accessed in any of a variety of other manners without affecting the function thereof For example, the controller may include or have access to one or more batteries, a gas power source, solar power source, or any other suitable source.

As illustrated in FIGS. 1A and 2, and as discussed herein, capsule de-duster 10 may include an encapsulator mount 62 which acts as an input for receiving capsules 80. In the illustrated embodiment depicted in FIG. 2, encapsulator mount 62 is divided into a bottom input portion 63 which is connected to back side panel 24b, and an optional upper input portion 64 which is connected to top cover 18. As further illustrated in FIG. 1A, upper input portion 74 can be arranged to mate with bottom input portion 63 when top cover 18 is in a closed position.

Encapsulator mount 62 may be configured to operate with or without a direct connection to an encapsulator. For example, when top cover 18 is closed, input portions 63 and 64 may combine to form a mounting structure which cooperates with a discharge site of an encapsulator to receive capsules. In particular, bottom input portion 63 may be inclined and thereby act as a ramp which guides capsules into housing 12 and onto capsule conveyor 20. When top input portion 64 is closed in around bottom input portion 63, it too can act as guide to received capsules and further acts as a barrier which prevents received capsules from falling off bottom input portion 63.

In light of the disclosure herein, it should also be appreciated that an encapsulator mount 62 having top and bottom input portions 63, 64 is exemplary only and not limiting of the present invention, and that other configurations can be employed without affecting the functionality thereof In fact, it is contemplated that capsule de-duster 10 can operate without top input portion 64. In particular, capsules 80 can be received by bottom input portion 63 which alone guides capsules 80 to capsule conveyor 20 for de-dusting.

As noted previously, capsule de-duster 10 can, in some embodiments, be configured to collect dust removed from capsules 80. When such dust is collected, it can be measured and accounted for and/or be reused for subsequent product runs, depending on the quality of the dust collected. In the exemplary embodiment illustrated in FIG. 2, dust is collected from capsules 80 and stored in a collection tray 16. For example, dust may be removed from capsules 80 by using a conveyor that includes screen 72, a shelf or some other surface that includes multiple perforations 75. Perforations 75 can be placed in any pattern. For example, perforations 75 may be spaced evenly along all or a portion of screen 72, may be set in a predetermined pattern, or may be randomly positioned.

As shown in FIGS. 2 and 3, to collect the dust which falls through perforations, a collection tray 16 can be inserted within or otherwise positioned in the interior of housing 12 and positioned beneath screen 72, such that as the dust falls through screen 72, gravity can direct the dust into collection tray 16. For instance, in the illustrated embodiment, collection tray 16 is situated below intermediate segments 73b of screen 72. Each of intermediate segments 73b can have multiple perforations 75 through which dust removed from capsules 80 falls as capsules 80 pass over segments 73b of screen 72. The dust then falls generally downward into collection tray 16 where it is at least temporarily stored. At a suitable time, such as at the end of a production run, collection tray 16 can be removed and the dust within collection tray 16 can be weighed and otherwise accounted for or reused.

As illustrated in FIG. 3, collection tray 16 may be removably and/or slideably connected to housing 12 so as to allow an operator to easily remove collection tray 16 and the powder collecting therein. As shown in FIG. 3, housing 12 may optionally include a tray support 38 which guides and supports collection tray 16 in-and-out of housing 12. Any suitable means for supporting tray 16 may be used. For example, in the illustrated embodiment, tray support 38 is a shelf along which collection tray 16 slides and which optionally includes bearings to facilitate sliding collection tray 16. In another embodiment, tray support 28 may include side rails into which tray 16 is inserted, or collection tray 16 may be supported directly by bottom panel 22. As will be appreciated by one skilled in the art, other suitable support means for connecting collection tray 16 to housing 12 may also be used without affecting the function thereof

To facilitate the insertion of collection tray 16 into housing 12, and/or the removal of collection tray 16 therefrom, collection tray 16 can have any of a variety of configurations. One example configuration is illustrated in FIG. 3, in which a collection tray 16 can include a bottom panel 49 on which powder removed from the capsules may collect. For example, bottom panel 49 may be a substantially flat plate which slides inward and outward with respect to housing 12.

To facilitate removal and/or insertion of bottom panel 49 with respect to housing 12, bottom panel 49 may be coupled to a front panel 52. Front panel 52 may, in turn, have one or more handles, knobs, or similar components to facilitate gripping by a user. In particular, in an embodiment in which bottom panel 49 is coupled to front panel 52, a user can use any such gripping component to move front panel 52 and thereby also insert or retract bottom panel 49. Front panel 52 can also be configured to facilitate securement and/or positioning of bottom panel 49 within housing 12. For example, as discussed previously, front panel 52 can include, according to one embodiment, a locking device which secures front panel 52 to housing 12. Moreover, housing 12 can also include an opening (not shown) through which bottom panel 49 is inserted into, removed from, or moved with respect to, housing 12.

According to one embodiment, front panel 52 is of a size which is larger, in at least one dimension, than opening in housing 12. This may be useful to, for example, insert bottom panel 49 into housing 12 and ensure proper placement of bottom panel 49 for receiving removed powder. For example, as bottom panel 49 is inserted into housing 12, front panel 49 can come into engagement with, and//or rest against, right side panel 24c of housing 12. Right side panel 24c, may include the opening through which bottom panel 49 moves, and which is smaller, in at least one dimension, than front panel 52 of collection tray 16. In this manner, as collection tray 16 is inserted into housing 12, front panel 52 of collection tray 16 engages right side panel 24c which restricts the further insertion of collection tray 16. Bottom panel 49 and front panel 52 can have dimensions suitable to ensure that when front panel 52 is adjacent right side panel 24c, collection tray 16 is in position to receive powder removed from capsules within housing 12. For example, when front panel 52 engages right side panel 24c, bottom panel 49 may be positioned directly below one or more perforations in a screen located above bottom panel 49 so as to receive powder falling through the perforations.

According to another embodiment, collection tray 16 can include side panels 48 and/or a back panel 50 which are coupled to bottom panel 49. Side panels 48 and/or back panel 50 can be desirable for any number of reasons. For example, side panels 48 and back panel 50 can, according to one example embodiment, be at least partially elevated with respect to bottom panel 49. Thus, as bottom panel 49 accumulates powder thereon, the accumulated powder can increase upward, and be contained within an open container defined by bottom panel 49, side panels 48 and back panel 50. Moreover, as collection tray 16 is moved, such as where it is being removed from housing 12, the powder accumulated on bottom panel 49 may shift. In an embodiment of collection tray 16 which includes side panels 48 and/or back panel 50, side panels 48 and/or back panel 50 can prevent the shifting powder from falling off bottom panel 49 and into housing 12.

Side panels 48 may also be desirable for a variety of other reasons. For instance, side panels 48 may include rollers (not shown) thereon which mate with a guide (not shown) within housing 12, thereby facilitating movement of collection tray 16 within housing 12.

Collection tray 16 as illustrated in FIG. 3 is but one example of a collection tray suitable for collecting powder removed from capsules within housing 12, and other configurations are possible without affecting the function thereof. For instance, other configurations of collection trays which are contemplated include other configurations of removable collection trays, or non-removable collection trays. Moreover, such trays may or may not be slideable with respect to housing 12. For instance, in another example embodiment, a collection tray is dropped into housing 12 when a screen (e.g., screen 72 of FIG. 2) is removed from housing 12.

As noted herein, powder that is collected within tray 16, or in any other suitable collection device, may thereafter be removed and thereafter weighed or otherwise accounted for, or it may be reused if the quality requirements permit. Reuse of the powder may be desirable to reduce production and product costs. For example, when an expensive powder is encapsulated, if the powder is not reused, then the cost of that powder is lost and is ultimately passed on to the consumer in the form of higher prices. Similarly, where a large amount of powder is being lost due to dust accumulation on the capsules, if that powder is not reclaimed and reused, it too leads to losses that are passed on to consumers. However, by collecting this powder such that it can be reclaimed and reused, these losses can be reduced or eliminated. As a result, production costs are decreased and the consumer can benefit from reduced prices.

Often, the powder which is encapsulated, and which is being reclaimed, may be a medicine, nutritional supplement or vitamin. For human consumption of these products, reused powders must be clean and cannot be dirtied by capsule de-duster 10, or they will not meet the necessary quality standards. If such powders are to be reused, the reclaimed powders must naturally be clean and free from debris, chemicals, or other foreign materials which would be unsuitable for consumption. Accordingly, capsule de-duster 10 can be adapted such that it can be easily cleaned and maintained clean. For example, to guard against impurities, capsule de-duster 10 may be manufactured of a material which is easily cleanable. For example, in one exemplary embodiment, capsule de-duster 10 is made from wear resistant and washable stainless steel. By way of example, medical grade or food grade stainless steel may be used to form housing 12, collection tray 16, and/or capsule conveyor 20.

In some embodiments, cleaning of capsule de-duster 10 is facilitated by components which are removable and/or which can be easily accessed for cleaning. For example, as depicted in FIG. 3, an example capsule de-duster 10 can be opened up for cleaning by the removal of a top cover and/or capsule conveyor. In particular, and as noted previously, the top cover is optionally removably secured to housing 12 and/or pivotally or slideably secured thereto in a manner that allows it to be easily opened to provide access to the interior of housing 12. Further, the capsule conveyor 20 (see FIG. 2) can be adapted to fit onto encapsulator mount 62 and capsule discharge 30, but be removable therefrom. In this manner, each of the top cover and the capsule conveyor can be removed and easily cleaned. Moreover, one or more of the side panels of housing 12 may also be removable or openable. For example, side panel 24d may be removably and/or pivotally coupled to bottom panel 22, thereby allowing a user to open or remove side panel 24d to access the interior of housing 12. It will be appreciated that various other side panels 24a-c could also be removable and acceptable for performing the function of removable side panel 24d.

Once the capsule conveyor, top cover, and/or side panels are removed or opened, the interior of housing 12 is easily accessible for cleaning. Moreover, collection tray 16 is optionally removable from housing 12 such that it can be cleaned separately, or it may be left within housing 12 when cleaned. Further, while the embodiment illustrated in FIG. 3 depicts motor 78 within the interior of housing 12, motor 78 may optionally be located outside of housing 12 such that it does not impede cleaning inside housing 12. Optionally, motor 78 may also be removable or may be enclosed in within a casing such that it can be easily cleaned while within housing 12. Accordingly, the interior of housing 12 can be easily accessed and manually cleaned and washed for subsequent, sanitary use.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A capsule de-duster and powder reclamation apparatus, comprising:
a housing;
a capsule input connected to said housing, said capsule input being adapted to receive one or more capsules as said one or more capsules pass into said housing; and
a dust collection system at least partially disposed within said housing, said dust collection system comprising:
a screen linked to said capsule input, said screen being configured to receive said one or more capsules from said capsule input, said screen further having a plurality of perforations therein through which powder removed from said one or more capsules can pass; and
a dust collector arranged to collect powder removed from the exterior surfaces of said one or more capsules after said powder passes through said plurality of perforations in said screen.

2. A capsule de-duster and powder reclamation apparatus as recited in claim 1, wherein the dust collection system further comprises
a powder removal mechanism linked to said screen, said powder removal mechanism being arranged to remove excess powder from exterior surfaces of said one or more capsules as said one or more capsules move along said screen.

3. A capsule de-duster and powder reclamation apparatus as recited in claim 2, wherein said powder removal mechanism comprises:
a vibration motor linked to said screen.

4. A capsule de-duster and powder reclamation apparatus as recited in claim 1, wherein said screen is removably disposed within said housing.

5. A capsule de-duster and powder reclamation apparatus as recited in claim 1, wherein said screen is gravity fed.

6. A capsule de-duster and powder reclamation apparatus as recited in claim 1, wherein said screen is cascading.

7. A capsule de-duster and powder reclamation apparatus as recited in claim 1, wherein said dust collector is slideably connected to said housing.

8. A capsule de-duster and powder reclamation apparatus as recited in claim 1, wherein said dust collector collects dust passing through a plurality of perforations in said screen.

9. A capsule de-duster and powder reclamation apparatus as recited in claim 1, said housing comprising a plurality of surfaces, wherein one or more of said plurality of surfaces are pivotally connected to other of said plurality of surfaces.

10. A capsule de-duster and powder reclamation apparatus as recited in claim 1, wherein said housing comprises one or more removable panels.

11. A capsule de-duster and powder reclamation apparatus, comprising:
a housing;
a capsule input connected to said housing;
means for removing excess dust from an exterior surface of capsules received by said capsule input; and
a powder collector for capturing dust removed from said capsules by said removal means, wherein the powder collector is configured to allow captured dust to be accounted for.

12. A capsule de-duster and powder reclamation apparatus as recited in claim 11, wherein said means for removing excess dust comprises a vibrating surface.

13. A capsule de-duster and powder reclamation apparatus as recited in claim 11, wherein said means for removing excess dust comprises a gravity fed shelf within said housing, said gravity fed shelf being arranged to receive capsules from said capsule input.

14. A capsule de-duster and powder reclamation apparatus as recited in claim 13, wherein said gravity fed shelf includes a plurality of openings, said plurality of openings having dimensions which permit dust removed from said exterior surface of said plurality of capsules to pass through said gravity fed shelf to said powder collector while substantially restricting said plurality of capsules from passing through said plurality of openings.

15. A capsule de-duster and powder reclamation apparatus as recited in claim 11, wherein said housing comprises a window for viewing said plurality of capsules as dust is removed from said capsules by said removal means.

16. A capsule de-duster and powder reclamation apparatus as recited in claim 11, wherein said housing comprises one or more sides and a cover.

17. A capsule de-duster and powder reclamation apparatus as recited in claim 16, wherein said cover is pivotally connected to said one or more sides.

18. A capsule de-duster and powder reclamation apparatus as recited in claim 11, further comprising:
a capsule output connected to said housing and linked to said means for removing excess dust;
wherein said means for removing excess dust is configured to substantially transport said capsules from said capsule input to said capsule output.

19. A capsule de-duster and powder reclamation apparatus as recited in claim 11, wherein said capsule input is configured to connect to an encapsulator.

20. A capsule de-duster and powder reclamation apparatus, comprising:
a housing;
a capsule input connected to said housing, said capsule input being adapted to receive one or more capsules and pass said one or more capsules into said housing;
a conveyor screen within said housing, said conveyor screen being configured to receive said one or more capsules from said capsule input, and said conveyor screen having a plurality of openings formed therein for receiving dust removed from exteriors of said one or more capsules; and
a vibration mechanism for vibrating said conveyor screen, the vibrations of said conveyor screen facilitating removal of dust from said one or more capsules; and
a dust accumulator disposed below said plurality of openings in said conveyor screen and removably connected to said housing, said dust accumulator being configured to collect dust removed from said one or more capsules to allow the collected dust to be reused or accounted for.

21. A capsule de-duster and powder reclamation apparatus as recited in claim 20, wherein said vibration mechanism includes a vibration motor.

22. A capsule de-duster and powder reclamation apparatus as recited in claim 20, wherein said vibration mechanism includes a controller for selectively varying the magnitude of the vibrations of said conveyor screen.

23. A capsule de-duster and powder reclamation apparatus as recited in claim 20, further comprising:
a support system coupled to said housing, said support system having a locking structure for substantially restraining said housing from moving as it removes dust from said one or more capsules.

24. A capsule de-duster and powder reclamation apparatus as recited in claim 20, said housing comprising one or more removable surfaces.

25. A capsule de-duster and powder reclamation apparatus as recited in claim 24, said housing comprising a cover and said housing forming a substantially closed environment.

26. A capsule de-duster and powder reclamation apparatus as recited in claim 25, said cover being selectively removable.

27. A capsule de-duster and powder reclamation apparatus as recited in claim 25, said cover having a view portion adapted to allow a user to view the interior of said housing as dust is being removed from said one or more capsules.

28. A method for de-dusting capsules, comprising:
receiving a plurality of capsules from an encapsulator, said plurality of capsules having dust on their outer surfaces;
vibrating said plurality of capsules to remove dust therefrom; and
capturing said dust removed from said plurality of capsules, such that said dust removed from said plurality of capsules can be reused or accounted for.

29. A method for de-dusting capsules as recited in claim 28, wherein vibrating said plurality of capsules to remove dust therefrom comprises:
conveying said plurality of capsules along a vibrating screen, said vibrating screen having a plurality of openings through which said removed dust falls after it is removed from said plurality of capsules.

30. A method as recited in claim 29, wherein capturing said dust removed from said plurality of capsules comprises:
collecting, in a removable tray, said removed dust after it falls through said plurality of openings in said vibrating screen.

31. A method as recited in claim 28, wherein receiving a plurality of capsules comprises:
connecting a de-duster to an encapsulator.
